(19) United States
(12) Patent Application Publication
(10) Pub. No.: US 2004/0170764 A1
(43) Pub. Date: Sep. 2, 2004

(54) Method for coating photoresist on a substrate

(76) Inventors: Yung-Chang Chen, Miao-Li (TW); Jia-Pang Pang, Miao-Li (TW); Chien-Ting Lai, Miao-Li (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/789,706

(22) Filed: Feb. 27, 2004

(30) Foreign Application Priority Data
Feb. 27, 2003 (TW) 92104340

(51) Int. Cl. B05D 5/12; B05D 3/12

(52) U.S. Cl. 427/346; 427/307; 427/58

(57) ABSTRACT

A method for coating photoresist (300) on a substrate (100) includes the steps of forming grooves (120) on the substrate, applying photoresist onto the substrate, and finally vibrating the substrate. The photoresist can be coated on the substrate evenly, and the efficiency of utilization of the photoresist is high.

### BACKGROUND OF THE INVENTION

1. Field of the Invention

The present invention relates to the field of photolithography, and particularly to a method for photoresist coating of a substrate.

2. Description of the Prior Art

Photolithography is a process of transferring geometric shapes on a mask to the surface of a silicon wafer or substrate of a liquid crystal display. Typically, the steps involved in the photolithographic process are: wafer cleaning; barrier layer formation; photoresist application; soft baking; mask alignment; exposure and development; and hard baking.

Photoresist application is an important step during photolithography, There are two types of photoresist: positive and negative. For positive photoresists, the photoresist is exposed to UV (ultraviolet) light wherever the underlying material is to be removed. In other words, “whatever shows, goes.” The mask, therefore, contains an exact copy of the pattern which is to remain on the wafer. Negative photoresists behave in just the opposite manner. Therefore, the negative photoresist remains on the surface wherever it is exposed, and the developer solution removes only the unexposed portions. Negative photoresists were popular in the early historical period of integrated circuit processing, but positive photoresists have gradually become more widely used since that time. This is because positive photoresists offer better process controllability for small geometrical features.

A conventional method for positive photoresist application is applying photoresist to the surface of silicon wafers (or substrates), and then spinning the silicon wafers at high speed. This standard technique is known as “spin coating,” and produces a thin uniform layer of photoresist on the wafer surface. Spin coating is performed at room temperature (20-25° C.), with a pre-measured amount of the selected photoresist being dispensed onto the silicon, glass or similar type substrate. The final film thickness depends on the selected spinning speed and time, as well as the curing temperature. However, an efficiency of utilization of photoresist material is only about 5%˜10%.

Another popular photoresist-coating method known as “slit and spinless” enables significant reductions in photoresist wastage. The “spinless” coater applies a coating of photoresist by scanning the substrate surface with a high-precision slit nozzle, and uses less photoresist material than spin coating. In fact, the slit and spinless method has a material utilization efficiency of about 90%. However, the photoresist cannot be distributed on the surface evenly. A modified method derived from slit and spinless is known as “slit and spin.” This method distributes the photoresist evenly. However, the method has a material utilization efficiency of only about 30%.

None of the above-described conventional methods can apply photoresist evenly with highly efficient of utilization of photoresist material.

Therefore, it is desired to provide a new method for coating photoresist which overcomes the above-described disadvantages of conventional processes.

### SUMMARY OF THE INVENTION

An object of the present invention is to provide a method for coating photoresist on a substrate evenly and with highly efficient utilization of the photoresist.

In order to achieve the above-described object, a method in accordance with the present invention includes the steps of forming grooves on a substrate, applying photoresist on the substrate, and vibrating the substrate. The photoresist can be coated on the substrate evenly, and the efficiency of utilization of the photoresist is high.

Other objects, advantages, and novel features of the present invention will become more apparent from the following detailed description when taken in conjunction with the accompanying drawings.

### BRIEF DESCRIPTION OF THE DRAWINGS

FIGS. 1A to 1E are schematic, sectional views of sequential stages in the coating of photoresist on a substrate in accordance with the present invention.

### DETAILED DESCRIPTION OF THE PRESENT INVENTION

Reference now will be made to the drawings to describe the present invention in detail.

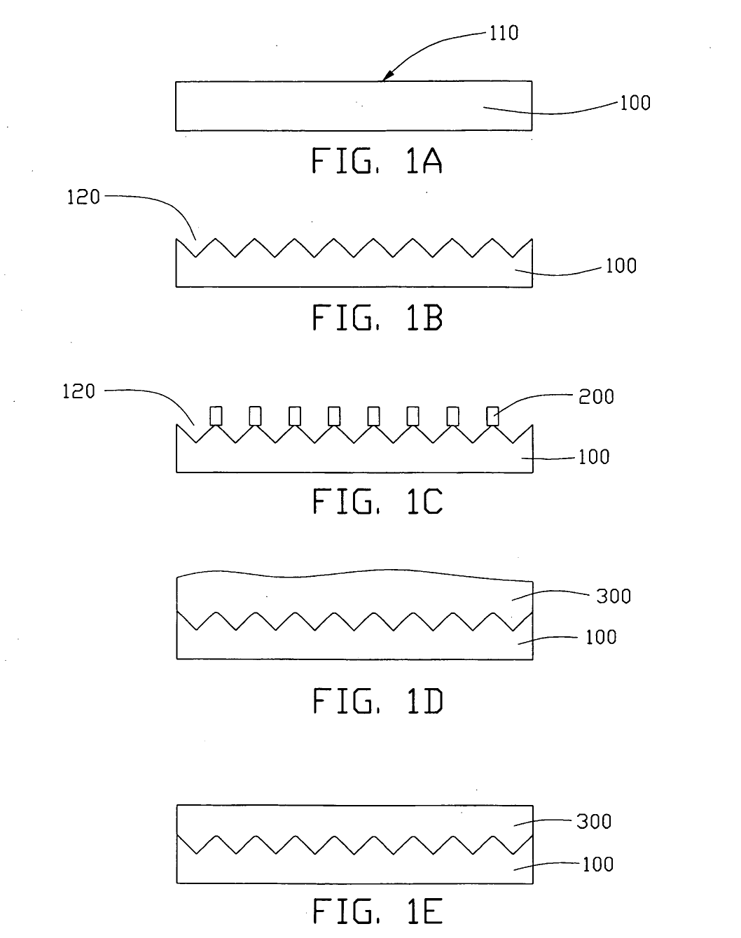

FIGS. 1A to 1E are sectional views illustrating stages in a process for coating photoresist on a substrate 100 of a liquid crystal panel. FIG. 1A shows the initial stage of providing a substrate 100, which has a surface 110 thereon. The substrate 100 can be made of glass or transparent resin.

In the next step illustrated in FIG. 1B, a plurality of grooves 120 is defined on the surface 110 of the substrate 100. The grooves 120 are contiguous and parallel to each other, and each groove has a triangular cross section.

FIGS. 1C and 1D illustrate the step in which a selected photoresist (not labeled) is applied onto the substrate 100 through a plurality of slit nozzles 200. The slit nozzles 200 are disposed on respective ridges (not labeled) that interconnect the grooves 120, and spray photoresist into the grooves 120. A pre-measured amount of the photoresist is dispensed onto the substrate 100. After the grooves 120 have been filled in, the photoresist is further distributed on the substrate 100 to form a photoresist layer 300. The photoresist is viscous, and distributes on the substrate 100 unevenly.

In the final step illustrated in FIG. 1E, the substrate 100 with the photoresist layer 300 thereon is put into a chamber (not shown). The substrate 100 is vibrated in horizontal directions until the photoresist layer 300 is evenly distributed thereon. A thickness of the photoresist layer 300 depends on a selected vibration speed and time, as well as on a selected curing temperature. Further and alternatively, the substrate 100 may be vibrated in vertical directions.

It is to be understood, however, that even though numerous characteristics and advantages of the present invention have been set forth in the foregoing description, together with details of the function of the invention, the disclosure is illustrative only, and changes may be made in detail to the full extent indicated by the broad general meaning of the terms in which the appended claims are expressed. For example, the grooves or recesses may be arranged in a matrix manner rather than the column type.

What is claimed is:

1. A method for coating photoresist on a substrate, comprising the steps of:
forming grooves on the substrate;
applying photoresist on the substrate; and
vibrating the substrate.

2. The method for coating photoresist as claimed in claim 1, wherein the grooves are contiguous and parallel to each other.

3. The method for coating photoresist as claimed in claim 1, wherein each of the grooves has a triangular cross section.

4. The method for coating photoresist as claimed in claim 1, wherein the photoresist is sprayed onto the substrate.

5. The method for coating photoresist as claimed in claim 1, wherein the photoresist is coated by one or more slit nozzles.

6. The method for coating photoresist as claimed in claim 1, wherein the substrate is vibrated in horizontal directions.

7. The method for coating photoresist as claimed in claim 1, wherein the substrate is vibrated in vertical directions.

8. A method for coating photoresist on a substrate, comprising the steps of:
forming recesses on the substrate;
applying photoresist on the substrate; and
vibrating the substrate so as to have the photoresist occupies said recesses evenly.

9. The method for coating photoresist as claimed in claim 8, further comprising a step of shaping a top portion of the photoresist with an flat exterior surface.

10. A method for coating photoresist on a substrate, comprising the steps of:
a) forming protrusions on the substrate;
b) applying photoresist on the substrate; and
c) vibrating the substrate so as to have the photoresist covering the protrusions and portions beside said protrusions evenly.

11. The method for coating photoresist as claimed in claim 10, wherein in step (b), a plurality of nozzles are respectively located right above apexes of the corresponding protrusions for spraying said photoresist.
